(19) United States
(12) Patent Application Publication
(10) Pub. No.: US 2024/0378307 A1
(43) Pub. Date: Nov. 14, 2024

(54) SYSTEM AND METHOD FOR ACCESS MANAGEMENT IN AN ORGANIZATION

(71) Applicant: Alevi Mario Dcosta, Salcette (IN)

(72) Inventor: Alevi Mario Dcosta, Salcette (IN)

(21) Appl. No.: 18/696,403

(22) PCT Filed: Oct. 6, 2022
(86) PCT No.: PCT/IB2022/059552

§ 371 Date: Mar. 28, 2024

(30) Foreign Application Priority Data
Oct. 11, 2021 (IN) 202121046323

(51) Int. Cl. G06F 21/62; G06F 21/60

(52) U.S. Cl. CPC G06F 21/6218; G06F 21/604; G06F 2221/2141

(57) ABSTRACT

System and method for access management in an organization are provided. The method includes restricting users from operating unsolicited data associated to the organization; identifying violation points by the users within the organization based on violation of policies; identifying one of illegitimate assignments or back door entry access assignments; detecting one or more parameters associated with a status of the corresponding users; restricting access of data associated with the authorized entities, to the users, based on organization hierarchy; generating a score representative of a criticality level of the access of data of at one of the organization; granting an access to the user, the authorized entities, to access the data associated to the organization; revoking an access of the user, the authorized entities, upon accessing the data associated to the organization upon execution of a pre-set instructions.

### EARLIEST PRIORITY DATE

This Application claims priority from a complete patent application filed in India having patent application Ser. No. 202121046323, filed on Oct. 11, 2021 and titled “SYSTEM AND METHOD FOR ACCESS MANAGEMENT IN AN ORGANIZATION” and a PCT Application no. PCT/IB2022/059552 filed on Oct. 6, 2022, and titled “SYSTEM AND METHOD FOR ACCESS MANAGEMENT IN AN ORGANIZATION.”

### FIELD OF INVENTION

Embodiments of the present disclosure relate to identity access management, and more particularly, to a system and method for access management of data within an organization.

### BACKGROUND

Computer security, cybersecurity or information technology security is the protection of computer systems and networks from information disclosure, theft of or damage to their hardware, software, or electronic data, as well as from the disruption or misdirection of the services they provide. Most organizations suffer cyber security related losses knowingly or unknowingly to the tune of millions.

One of the key reasons to compromise on the cyber security via some of the conventional approaches is that solutions from the conventional approaches fail to provide the organization a well-defined protocol to manage the enormous access data or access containers such as application entitlements, application roles, IT Roles, business roles, and the like, present in the entire organization.

In addition, there is no clarity in names of defined access data in the conventional approach such as low-level access such as application entitlements have non-user-friendly names and usually do not reflect the effective access the entitlement gives, when assigned to an identity. The same goes to IT Role. Coupled with thousands of entitlements or hundreds of roles, it becomes difficult to understand what access container has what effective access. Assigning a wrong access container to an identity result in compromised security. Given so many other access containers that may have similar access data, choosing the right access container could mean a daunting and non- secure task. SOD policies are written based on combinations of created access containers (IT Role, entitlements) so that non conflicting access containers are not assigned to the same identity. These too are placed within the global policies catalog, thereby creating all the more chaos with respect to clarity. Thereby resulting in non-clarity whether the specific access containers have been incorporated into SOD policies that ensure non-conflicting assignments. The non-structured creation of access container objects loses the objective of access management. What is achieved is only a layer of abstraction in the form of role for all available access assignments.

When access is to be assigned to an identity, all enterprise entitlements including critical ones are accessible for assignments. These can be directly assigned to the identity by a manager or an authorized person and via organization-roles or IT-roles. This poses a threat by which if the manager does not know the full repercussions of the entitlement assignment visa-vis current accesses, this could mean a security disaster. In addition, due to the enormous access data or entitlements spread out across identities within organization, organization roles are created having combinations of the same. With each application typically containing a minimum of hundred entitlements and spanning across many different applications, organization servers, cloud resources, or the like, combinations of the entitlements assigned across organization roles results in a whopping number of organization role to choose from. Besides, manager or any authorized person may not be aware if the organization role is associated with a SOD policy or not.

Furthermore, SOD Policies are created based on conflicting organization roles. With so many access containers against which policies are to be created, understanding the conflicts may lose the purpose. Thereby, access controls created to ensure right access is assigned are not well organized that could result resulting in dubious accesses assigned to identities. Directly assigning access to identities without assignment reviews by relevant stake holders could potentially mean an incorrect role a chosen for the wrong organization function. Also, lack of structured access management, solutions rely on artificial intelligence to guide them that the right set of accesses are assigned to identities based upon history of that assignment resulting in access violations or data breaches.

In addition, since policies are executed globally and do not have specific policies applied to specific areas of the enterprise. For example, a certain business unit requires the same check to be performed everyday would result in violations for all other business units of the enterprise. Also, supporting identities to work in multiple departments or sister concerns is difficult as identities are hard tied to work for manager or an authorized entity. The solution of the conventional approach does not provide a complete solution to these problems.

Moreover, it is imperative to break down the access assignment and policy executions task to small manageable chunks within the enterprise where management can have clarity of what access is needed in what part of the enterprise and assign it to that security perimeter of the enterprise beyond which no one knows that entitlement is even present. This security perimeter within the enterprise ensures that it is compliant to the enterprise access management rules including correct assignment of access to all its employees and non-violation of all policies from time to time.

In addition, low level data must not be accessible or even viewable by employees of the organization. It is not required for all employees to know what all accesses are present in the enterprise. Flashing the keys to the treasure can only invite temptation to steal and know which key to use to steal.

Furthermore, in the identity lifecycle, the identity of a user undergoes various changes of state right from joining to leaving the organization. These states include change in designation, movement to other sites or departments, on leave, resumes duty, rename, rejoin, or the like. All these identity states are managed by a specific department like HRD typically managing the identity states in a database. Manager or authorized entities are involved in performing the retrospective changes in the entitlements or resource accesses by identity. This interleaved execution is error prone and is not accounted for. For instance, if there is a promotion or a demotion executed by a HR on the identity and is not faithfully carried out by leaving behind certain accesses which are no longer applicable to the new designation, the data security is being compromised, thereby making the conventional approach less reliable, less secure and less efficient. Since these events directly involve human resources, these events must be initiated by the HR and trigger workflow process that would automatically add/remove access containers relevant to the event without direct involvement of manager. Manager's role in these would only be to authorize (review and approve) the change.

Furthermore, no Direct assignments such as no person should be able to directly assign access to an identity. This includes even the Manager. All access assignment must go through a workflow process involving two or more personnel reviewing the access assignment. For instance, when an identity requests access, this must be a two or three step action where IT Admin or other competitive authority decides what IT access can be assigned to the request provided it is not violating any policies and another person i.e. Manager from managers workgroup decides it is appropriate to assign the requested IT access to the identity. This improves security by involving IT Admin or other competitive authority who fully knows what IT function is assigned in the process and lets Manager only decide whether the access is to be permitted or not.

Also, then an identity requests additional access and is assigned by his manager, it is usually not time bound. Not doing this has its obvious consequences. Access assignments should be time bound. i.e., manager should be able to specify the timeline for the access stays assigned. Beyond which it is revoked.

Moreover, the conventional approach lacks dictum-based identity access assignment, more specifically dictum-based access management ensures every personnel of key functions (HR, IT and Management) of the organization is involved in the access assignment process. Lack of this results in a single person deciding what access is to be assigned to an identity even if he or she does not have clarity of the access assigned.

Managed system/entitlement owner to review critical entitlement, more specifically, on critical managed system, all new user account provisioning must be reviewed by managed system owner before user account provisioning happens. Similarly, entitlement owner must review critical entitlements before being provisioned on a managed system. This avoids overcrowding or undesired or frivolous access assignments.

Backdoor entry access assignments to throw violations. All access assignments must be made from solution only. Any access that has been discovered on the managed system that has not been explicitly assigned, must result in enterprise level policy violation.

Organization unit specific policies, more specifically policies specific to the organization unit access containers are created allowing Organization unit to create its own set of policies beside enterprise level policies to ensure Organization unit specific ‘segregation of duty’ rules for improved security.

Furthermore, employee works for, more specifically an employee is hired to carry out certain activities on behalf of the organization and is placed in a specific organization-unit to fulfill its objectives. Therefore, the misconception of employee ‘works for’ manager relationship is less fitting. A more appropriate relationship of an employee within an organization is with the organization-unit. This applies for manager also, who is an employee of the organization-unit. This philosophy makes it simpler and clearer to implement employee movement to other organization- units or working for multiple organization-units and also for implementing scenarios when manager is replaced, transferred or left the organization.

Also, non-direct assignment of tasks, more specifically assigning workflow process tasks directly to an authorized user binds the task to the specific user. Besides this, executing critical actions with no one else watching introduces security loopholes. It is best when the task is assigned by an identity within a group containing two or more authorized persons. Also, when a task is carried out, there must be someone who can oversee the execution or execution inputs. This brings more visibility and transparency.

An identity lifecycle view, more specifically all accesses assigned to the identity in its lifecycle within the organization must be trackable. This can be achieved by providing a view of all the events, the processes involved, and the accesses assigned during the tenure of the identity within the organization.

Hence, there is a need for an improved system and method for access management of data within an organization to address the aforementioned issues.

### BRIEF DESCRIPTION

In accordance with an embodiment of the present disclosure, a system for access management in an organization is provided. The system includes one or more processors.

The system also includes a data denial management module configured to restrict one or more users from operating or viewing unsolicited entitlements, IT Role or policies associated to the organization-unit, only authorized personnel (IT) are able to operate on the entitlements associated with organization-unit so as to create access containers such as IT Role.

The system also includes a security breach pointing module configured to identify one or more violation points by at least one of the one or more users within the organization based on violation of one or more policies by the corresponding one or more users, wherein the one or more policies is created by one or more authorized entities within the organization and to identify one of illegitimate assignments or back door entry access assignments by the one or more users, upon comparing access data present on identity of the organization-unit with assigned access data of the corresponding one or more users using one or more attributes associated to the corresponding one or more users. The system also includes an access management module configured to initiate appropriate workflow process on detection of one or more parameters associated with a status of the corresponding one or more users. The system also includes a data hiding module configured to restrict access of data associated with the one or more authorized entities, to the one or more users, based on assignment of the user to the organization-unit and one or more organization-unit hierarchy. The system also includes a data assessment module configured to generate a score representative of a criticality level of the access assigned within the organization-unit, the one or more authorized entities, or a combination thereof, by the one or more users. The system also includes a data access module configured to grant an access to at least one of the one or more user, the one or more authorized entities, or a combination thereof to access the data entitlements, role, policies, or the like associated to the organization, based on one or more conditions. The system also includes an access revocation module configured to revoke access of at least one of the one or more user, the one or more authorized entities, or a combination thereof upon accessing the data associated to the assigned organization-unit upon execution of a pre-set instructions.

In accordance with another embodiment of the present disclosure, a method for access management in an organization-unit is provided. The method includes assigning entitlements to at least one person within an organization unit based on a designation associated to the corresponding at least one person. The method also includes enabling the at least one person within an organization unit to view the assigned entitlement. The method also includes enable at least one authorized user within an organization unit for creating one or more role objects, wherein creating one or more role objects comprises IT roles and organization roles fitting various IT functions of the organization unit. The method further includes limiting a number of accessible entitlements to only a few for enabling the at least one authorized person to focus on understanding the accessible entitlements and assigning accessible entitlements to one or more right identities within the organization unit. The method also includes ensuring access is only assigned and treating backdoor access entries as violations by one of at least one person or at least one authorized user. The method also includes creating SOD policies within the organization unit for ensuring non-conflicting access is not assigned to same identity. The method also includes involving key personnel in the process of access assignment for mapping employee or identity status changes to the right access changes without changing the meaning of a job profile of the at least one person. The method also includes limiting malicious and unintended assignment of access to the wrong identities within the organization unit.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram representation of a system for access management in an organization in accordance with an embodiment of the present disclosure;

FIG. 2 is a block diagram representation of a processing unit located on a local server or on a remote server in accordance with an embodiment of the present disclosure; and

FIGS. 3a and 3b are flow charts representing steps involved in a method for access management in an organization in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and method for access management in an organization. As used herein, the term ‘access management’ refers to data access management, wherein the data may be associated to the organization. In one embodiment, the organization may be one of a company, an educational institution, a financial institution, or the like.

As used herein, the term ‘identity’ may be defined as a person, a device or a bot that performs tasks on digital data or resources. The term ‘access control based on role’ is defined as a type of access control, where the resource access control is assigned to user group which is an object that can contain one or more user account entries. This means, that the users present in a certain user group has access to the specified resource.

Further, the term ‘access control based on attributes’ is defined as the is defined as a type of access control, where the resource access control specifies a rule which resolves to a certain value. Any user account that has that value possesses access of the resource in question.

Furthermore, the term ‘entitlement or user group’ is defined as a RBAC Object created on an application that grants permissions to users of the application that possess the entitlement. These objects do not usually have business friendly names or inferable as to what the access power the group gives access to. Depending upon the application or managed system involved, the name structure differs. For example, An ldap entitlement name can be CN=group1, CN=usergroups,DC=Acme,DC=com. They are usually created by IT admins on the concerned application to provide access to perform a set of functions on the concerned application.

Similarly, the term ‘application role’ or ‘managedsystem role’ or ‘approle’ may be interchangeably mean ‘the entitlement’. However, it is different from the entitlement which is assigned to a user account present on the application. Whereas, application role is a role object created on the application defining what access can be attained by a user possessing that role supplied during the application login assertion. As per which, the application requires an identity to login into the identity provider (discussed system) with which a trust has been established to allow application access without requiring user credentials (user account/password) to access the application. The app resources that can be accessed by the user are defined by the role specified in the user assertion data sent by the identity provider when its user tries to access the application with which trust has been established. Application roles are to be treated in the same way as entitlements and are assigned to the identity as per the rules discussed in this document. The approle may be assigned to the identity via identity attributes or proxy user account attributes or via approle entity attributes or the likes. So that when identity accesses the application, the app role(s) assigned to the identity is present within the app login assertion data. The concept is typically used in single signon (SSO) mechanisms (SAML) to login users into an application by logging in once into an identity source (Ex.Google,Facebook).

The term ‘organization role’ may be used interchangeably, is defined as an access container containing a set of entitlements created to fulfill a job profile or job title. The organization role is created so people having a specific job profile may be assigned the organization role(s). Also, the term ‘IT Role/IT Role’ or ‘IT Access/IT Access’ can be used interchangeably and is defined as an access container containing a set of entitlements created so people can be provided additional access apart from the assigned organization role to carry out specific additional IT functions not necessarily defined in the job profile. The term ‘access data’ refers to anything that assigns access to an identity. This includes entitlements, IT role. Also, the term ‘policy’ is defined as a segregation of duty rule created to ensure accesses are assigned so that conflicting accesses are not wrongly assigned. Password Policies to ensure for all user passwords, same policy is observed. Furthermore, the term ‘entitlement owners’ are defined as owners of critical or non- critical entitlements. The term SOD implies ‘Segregation of Duty’

Workgroup is an object containing a group of persons sharing same responsibilities. Ex All Managers Workgroup, OU Managers Workgroup, All HR Executives Workgroup, OU HR Executives Workgroup, OU IT Admins Workgroup and the like. It enables to share the same data view as its peers enabling all within the group to oversee tasks executed by its peers. In general, workflow process tasks are assigned to the workgroup rather than to a specific individual. This reduces predictability on who will execute the task and improves transparency in process execution.

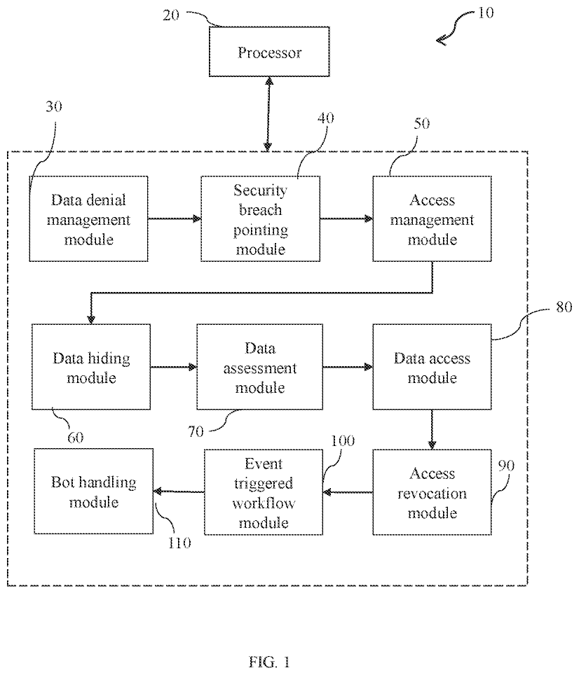

FIG. 1 is a block diagram representation of a system 10 for access management in an organization in accordance with an embodiment of the present disclosure. The system 10 includes one or more processors 20. In one embodiment, the system 10 may include a data distribution module which may be operable by the one or more processors 20. The data distribution module may be configured to distribute a plurality of enterprise access data (entitlements, approles, generic ITRoles) across one or more organization units (OU) based on one or more functions of the organization-unit and the one or more functions of the designation within each of the organization unit.

The system includes a module configured to distribute a plurality of enterprise application entitlements and approles across one or more organization units based on the function of the organization units and further categorizes entitlements based upon the IT function of a job profile within the organization unit. It treats each organization unit as a security perimeter wherein each organization unit is concerned with its own access and policy management.

The system associates an identity to an organization-unit if he is an employee within an organization-unit. Only the IT access required to perform the job function as described in the job description of the organization-unit is assigned to the identity via role attached to the designation object. For additional access, employee has to request which results in a workflow process requiring IT Admin or related authorized personnel to review the request and assign an appropriate IT Role provided it does not violate any SOD policy which is then reviewed by Manager or related authorized personnel in a separate step of the process as to whether to allow the IT Role assignment or not.

The system 10 includes a data denial management module 30 configured to restrict one or more users from operating unsolicited data associated to the organization, wherein the unsolicited data is unassigned to the corresponding one or more users. In one embodiment, the data denial management module 30 may be configured to treat each of the multiple organization unit as a security perimeter of its own, wherein all identities, access containers, policies, workflow processes and settings which may be associated to the organization-unit may be governed by the system 10.

In one specific embodiment, the data denial management module 30 may be configured to assign access data across the enterprise using one or more organization constructs, wherein the one or more organization constructs may be dependent on the kind or type of the organization structure. In such embodiment, the one or more organization constructs may be structured based on at least one of functional, divisional, matrix, team, networking, or the like.

In one specific embodiment, when the data may be the access data or IT resources, the one or more organization constructs may be at least one of enterprise structure, department, designation, HR, IT Admin, Manager and employees, wherein a manager(s), IT admin(s), HR(s) is assigned to each organization unit as stake holders in the security of the organization unit to facilitate appropriate assignment of access data governed by the bounds of applicable designation, organization unit policies and within the defined identity event workflow. All personnel are assigned to a workgroup of managers, IT Admins and HRs for that OU.

More specifically, the data denial management module 30 enables distributing access data across organization-units such that access data is accessible only where needed. And can be assigned only to the one or more present within the organization-unit.

For example, tally server accountancy related entitlements may be exclusively assigned to an accounts department of the organization, and further on may be assigned to accountants. In such a scenario, no other organization-unit could gain access to the accountancy related entitlements. However, if a sales team of the same organization wants access to prices of items sold within the organization, they could attain access to sales related entitlements of Tally by assigning the sales entitlement of Tally to the sales organization-unit. Likewise, accounts department could have no way to gain access on sales entitlements.

Furthermore, the system includes a security breach pointing module 40 configured to identify one or more violation points by at least one of the one or more users happened within the organization based on violation of one or more policies by the corresponding one or more users, wherein the one or more policies is created by one or more authorized entities within the organization.

The security breach pointing module 40 is also configured to identify one of illegitimate assignments or back door entry access assignments by the one or more users, upon comparing access data present on identity of the organization with assigned access data of the corresponding one or more users using one or more database queries associated to the corresponding one or more users. In one embodiment, the one or more attributes may be corresponding to at least one of the multiple organization units.

In one exemplary embodiment, the security breach pointing module 40 may be configured to pin-point the access violations happened within any organization unit based on the access violation and SOD policies created within the organization unit and those at global level within the corresponding type of the organization.

More specifically, separates management related activities towards an identity from IT activities towards the identity. All organizational terminologies and actions pertaining to HR are maintained at HR level (identity status related to joining, promotion, resignation, and the like), Management is maintained at management level (approving and authorizing the access) and all access data and related terminologies may be maintained at IT level (assigning access containers to relevant designation or new access requests after thorough cognizance of the access provided).

Further, each of the multiple organization units may function as an independent security entity that has to be responsible for creating an access containers such as, but not limited to, an IT Access (IT Role), an organization role, or the like, to define designations of the corresponding one or more users in the organization based on job description, assigning appropriate organization role to a designation, assigning designations to identities with matching job profiles, managing risk scores and managing risky identities, performing self-access-certifications, managing access violations, or the like. More specifically, all accesses may be managed within the corresponding at least one of the multiple organization units. Manager or the one or more authorized entities may approve access requests only of a specific category of the one or more users based on the corresponding one or more organization units and does not manage the access of the remaining users of the one or more users. The one or more authorized entities may specify only accesses defined within the organization-unit. The one or more authorized entities can create violation policies specific to at least one of the multiple organization units.

Referring to the above-mentioned example, in order to achieve this beside the manager and employees within at least one of the multiple organization units, an auxiliary team of HR Executive and IT Admin may be assigned to the corresponding at least one of the multiple organization units to carry out key HR and IT activities of the multiple organization units.

To better utilize resources, the same HR Executive and IT Admin personnel may also be assigned to multiple non-related organization-units or may be assigned at a top-level organization unit.

Furthermore, the system 10 includes an access management module 50 configured to detect one or more parameters associated with a status of the corresponding one or more users. In one embodiment, the one or more parameters may include at least one of an identity status change event, a responsibility change, or a combination thereof within the organization. More specifically, the term ‘dictum’ implies authority of assigned dicta of HR executives to change identity status or primary department Id attribute thereby initiating change event-based workflow process and provide inputs to the workflow process. Dicta of assigned Manager(s) reviewing the change, authorizing it or to the least, acknowledging the change and dicta of OU assigned IT Admins specifying the access container best suited for the change.

In one specific embodiment, the status of the one or more users may be at least one of new joining, movement to a different site, role change, or the like within the HR database to trigger corresponding workflow and to intimate to HR who provides needful inputs to the workflow instance. Based on the input from the HR and of the IT Admin, the module is configured to allow the manager or the one or more authorized entities to perform approval of such inputs.

In one embodiment, a data hiding module may be configured to restrict each identity and manager or the one or more authorized entities within at least one of the multiple organization units from self-assignment of access data, entitlement or resources or perform direct assignment of access to another identity without being required a justification and without involving one or more personnel approving assignment of access via workflow.

For example, when a manager or the one or more authorized entities require a new hire that involves a specific skill, HR Executive assigned to at least one of the multiple organization units may create a new designation object which will describe the job profile of the user. Further, the IT Admin has to create an organization role that fits the job description of the designation and assign it to the designation. Once when the person joins the organization, the hiring HR Executive initiates the workflow in which a task of assigning the designation to the new hire as per job profile discussed by the manager or the one or more authorized entities. Once assigned and approved by the one or more authorized entities, the designated access is assigned to the corresponding user of the one or more users.

The system 10 further includes a data hiding module 60 configured to restrict access of data associated with the one or more authorized entities, to the one or more users, based on one or more organization hierarchy. More specifically, in one exemplary embodiment, the data hiding module 60 may be configured to restrict the one or more users such as employees from viewing user groups, IT roles and resources present in at least one of the one or more organization units or enterprise level. The data hiding module 60 may also be configured to provide an option to view low level IT data (such as resources) to ascertain the approval. More specifically, low level access data such as user groups and resources must be managed and viewed only by IT department or competing authority and not to the employee, wherein the employee corresponds to a set of users of the one or more users. The data hiding module 60 may expose management related access objects such as designation to the management.

Furthermore, the system 10 includes a data assessment module 70 configured to generate a score representative of a criticality level of the access of data of at one of the organization, the one or more authorized entities, or a combination thereof, by the one or more users. In one exemplary embodiment, the data assessment module 70 may be configured to allow IT manager and a compliance manager to evaluate policy violations based on which the data assessment module 70 may assign a criticality score to one or more IT access object to mark the access criticality. In such embodiment, the data assessment module 70 may further be configured to periodically assess the critical objects based on the criticality.

In one specific embodiment, an identity works for an organization-unit and not work for manager. Manager views all the employees or the one or more users within the corresponding one or more organization units and is able to approve or reject requests made by the one or more users. Further the IT Admin or the likes may create access containers such as IT access objects as per IT tasks pertaining to the function of the organization unit and organization roles based on the job profiles required by the corresponding organization units. The HR Executive or the likes may create designations corresponding to job descriptions to which IT Admin assigns organization role. HR Executive or the likes to execute access assignment activities against identity events such as joiner, promotion or demotion, on leave or resumed duty, movement to another site or OU, secondary organization-unit assignment, rename, leaver and joiner. Manager of the OU to approve or reject (authorize) the assignments depending upon the desired IT activity involved. This process may ease the work pressure to handle workflow activities assigned to the manager or the one or more authorized entities when the corresponding one or more authorized users is on leave or leaves the company so that the corresponding activities can be carried out by a new replacement. Manager can only approve optional IT access to the one or more users.

Furthermore, the access violation policies may be created to ensure no one gets access beyond what has been designated. In one exemplary embodiment, all identity changes right from joining to leaving such as promotion, demotion, movement to other OU, rename, or the like may be initiated by HR and not by manager. Manager may only be permitted to approve or disallow assignments as part of the workflow by providing appropriate reason.

In one exemplary embodiment, the system 10 may include an event triggered workflow module 100 configured to operate an access to of the one or more users based on one or more events associated to the one or more users. In such embodiment, operating the access may be at least one of manage, control, revoke access to one or more resources based on one or more events, or the like.

In one specific embodiment, only access data may be required by the one or more organization units which may be imported into the organization-unit. This may be done by finding all the access currently available on all one or more users of the corresponding one or more organization units. Alternatively, the organization unit may choose to allow IT Admins or the likes to create access containers such as organization role and IT role based on access required in the assigned OU.

Furthermore, the system 10 includes a data access module 80 configured to grant or revoke an access to at least one of the one or more user, the one or more authorized entities, or a combination thereof, based on one or more conditions. In one embodiment, the one or more conditions may include at least one of a identity, work time comprising a date and time to solicit logging credentials of the one or more users within the organization-unit, or a combination thereof.

In one exemplary embodiment, with correct access data available to the organization-unit, IT staff may or the likes be required to create the organization role and IT access objects as required by the organization unit job profile needs. IT access objects must contain set of accesses required to perform a specific IT function. Access data may be in terms of entitlements or resource access with specific permissions. Whereas the organization role may contain a set of IT access objects that may enable the identity to perform a set of IT functions. Designation is an entity that is defined by hiring HR executive as per the desired job profile, to which a fitting organization role is assigned by an IT admin. If the designation already exists, there is no need to create a new one. Designation entity provides an abstraction layer for organization role. As in, the organization role may be synonymous to IT what designation is to HR. The organization role must contain only the base minimum access required by a designation job profile. Designation object is allowed to have only one the organization role based upon the job profile defined within the designation. In order to avoid duplication of IT access objects, IT access objects that are common to the entire enterprise may be defined at a root of a corporate tree and may be marked generic. Additional access required requested by the one or more users initiates an access request workflow wherein the IT Admin or competitive authority specifies a specific IT Access object (IT Role) to the request and is then reviewed and authorized by the manager or the one or more authorized entities upon request. All of the above is however, subjected to SOD policies which may be evaluated each time an IT access object or the organization role object is created or updated or assigned to an identity of the corresponding one or more users.

In some embodiments, there may be two broad categories of policies associated to the organization. One global policies and second organization unit policies. The global or corporate policies may be mandated and may be evaluated across an enterprise. Access violation policy is a corporate policy that ensures all identities within the entire organization do not possess any access in addition to the ones assigned to the identity by way of organization role and IT access. Organization-Unit policies may be defined within each organization unit as per specific requirements of the organization unit. Therefore, in the corporate hierarchy, each organization unit could potentially have a set of policies. The set of policies defined within an organization unit when marked generic are applicable to all organization units below the organization unit defining the policy. This ensures creation of policies that are common to all organization units below a specific organization unit of the corresponding organization. Following types of policies may require support:
A) Segregation of Duty (SOD) Policies can be entitlement SOD or resource access SOD. Entitlement SOD evaluates only entitlement violations within identities and access containers. Whereas Resource SOD evaluates resource access violations by identities and access containers.
B) user account policies such as last login, bad password count, or the like.
C) user group policies include max assignments, side by side critical entitlement assignments, or the like.
D) password policy
E) Risk policy
F) Non-mitigated violations policy.

Each policy violation may be intimated to manager or the one or more authorized entities and/or higher manager. Policy to create violation if a prior violation has not been mitigated within a stipulated time. Policy violations may be archived, maintained and analyzed by compliance manager or one or more authorized entities.

In one embodiment, the IT manager or the compliance manager may take a note of evaluating policy violations and note where critical entitlements or resources have been assigned and used. Besides marking entitlements or resources as critical, a criticality score can be assigned to an IT access object to mark the access criticality. Identities with high risk need to be assessed from time to time by the data assessment module 70.

Furthermore, timely self-certification and enterprise access certification may be initiated by the compliance manager or competitive authority and may be adhered by managers or the one or more authorized entities of each of the multiple organization units who will certify access data of each employee within the organization unit being managed. If an access is disapproved by the one or more authorized entities, a workflow may be initiated suggesting disapproval which will initiate de-provisioning of access. Since the access would be part of an access container, the IT admin may have to review the container contents and accordingly modify the same. This will result in change propagation that will un-assign or assign changed access data to the one or more users to whom the access container is assigned. If the access data is structured well and identities have been assigned appropriate access data via designation entity and the IT access and access policy violations mitigated, the organization unit employee access may stand certified.

In one exemplary embodiment, application settings are default settings pertaining to organization units, managed systems, entitlements and users. Examples of settings may include at least one of user password policy, workflow name to trigger on a certain event, change password period, or the like. If a certain organization unit requires a different password policy to be adhered from the default password policy, the organization unit may override the application-level password policy to suit the condition. This will enforce the one or more users to specify password as per the organization unit specified password policy. Similarly, if the organization unit requires a different workflow to be initiated on a certain event, the corresponding event setting may be modified to specify a different workflow definition.

In another exemplary embodiment, the one or more users within the organization may undergo various changes including promotions, on leave, moved to a different site or organization-unit, renamed, or the like. These trigger workflows that may or may not require human involvement for user inputs or approvals. Once all the desired inputs are found, the workflow executes one or more APIs that may do the needful provisioning across the application. For example, if a person is on leave, the company leave application would invoke the employeeonleave( ) API and the workflow would automatically revoke all identity access. Similarly, if a new identity info is found within the HR directory, the joiner workflow would be triggered, and the hiring HR intimated to specify the designation specific to the identity.

Not all workflows are event driven. For example, the change in designation or mover workflow may be initiated by the HR executive handling the organization unit.

Furthermore, the system 10 may include a multiple organization support module configured to allow at least one of the one or more users to access resources from multiple organization units based on the assigned work, designation, role of the identity within that organization unit, or the like.

More specifically, in one exemplary embodiment, when employees work in two different departments or sites of the same organization. For example, a doctor may work as a surgeon in the hospital and as a professor in the medical college of the same organization. An identity may be assigned as a secondary organization unit along with the primary organization unit. This is the secondary organization unit assignment workflow that may be initiated by the secondary organization-unit HR Executive. As part of the workflow, the secondary OU HR Executive would assign the designation pertaining to the secondary organization-unit and after approvals from primary organization unit, the HR executive and manager or the one or more authorized entities followed by final approval by secondary organization unit manager, the secondary organization unit is assigned to the identity.

In one embodiment, the system 10 may include a customer identity access management module which may be configured to allow a customer identity of an enterprise to access the enterprise resources based on the access assigned to the one or more users within the organization unit specifically created for customer. More specifically, with an exemplary embodiment, to manage customer accesses, the customer identity data may be again pulled into organization unit containing all customers for the specific site or perhaps placed into a single organization unit meant for customers. The IT access objects may be created to assign Customers specific IT capabilities as required by the customer request. Just as an employee requests access, customer could request access that would be reviewed and approved by the customer relationship manager by assigning appropriate IT Access object.

In another embodiment, the system 10 may include a work time-based access management module configured to allow the identities of the one or more users to specify the date and time to solicit logging into the organization unit access. Further, the work time-based access management module may be configured to allow the identities of the one or more users to access the data and resources pertaining to a specific organization-unit only at the specified time and date. More specifically, in an exemplary embodiment, when an employee login, the employee may have access to applications via single sign on or directly logging into the assigned application. When the employee works in multiple organization units, the solution shows all the application accesses attained due to cross organizational access assignments. The work time-based access management module may enable the organization unit to specify date and time to solicit logging into the organization-unit access, so that the employee may have access to resources pertaining to a specific organization-unit only at the specified time and date.

Also, besides policies created against entitlements, IT access policies may be created to ensure conflicting IT access objects which may not be assigned in the same organization role or to an identity by way of assigning an organization role via designation and then assigning a conflicting IT access policy. These policies may be created in the organization unit that has access to both the IT access objects either within a leaf OU or a parent OU.

In addition, as part of providing access on any application server, the user account may be usually required to be created within a server against which access is provided. If the service is of critical nature, the organization may decide to include a certain configuration that does not permit every other user account provisioning request to execute as part of a user provisioning action. When this is set to be true, the provisioner may stop for approval from managed system or application owner who is intimated of the user account provisioning action. If approved, the provisioner provisions the user account on the server and then proceeds with the provisioning of the entitlements.

Moreover, once a user account is present within an managed system, the user account may be placed in various user groups. If there are certain user groups that are critical in nature and IT may not want to keep a tag of who gets access on the critical user groups, an entitlement setting is ensued against the critical entitlements. When set to true, the corresponding entitlement owners are informed whenever the provisioner attempts to provision the entitlements onto the user group. If approved, the entitlement is provisioned against the user account. Else, the entitlement assignment may be skipped.

Furthermore, the system 10 includes an access revocation module 90 configured to revoke access of at least one of the one or more user, the one or more authorized entities, or a combination thereof upon accessing the data associated to the organization upon execution of a pre-set instructions. More specifically, with an exemplary embodiment, the access revocation module 90 may be configured to allow the manager or the one or more authorized users of the organization unit to review a new access of a new identity assigned by an IT manager during the approval phase. Further, the access revocation module 90 may be configured to allow the manager to approve and assign a timeline for the access, such that after the timeline the access may be auto revoked.

In one exemplary embodiment, the system 10 may include a sister organization support module which may be configured to allow the organization to incorporate one or more sister organization, sites, locations, or the like and to manage the corresponding accesses.

In another exemplary embodiment, the system 10 may include comprising a bot handling module 110 configured to manage one or more bots as identities within a corresponding organization unit which is maintained by the one or more authorized entities, wherein the operation of the bot comprises start, stop and termination, assignment of access, or a combination thereof to be performed upon being assigned by the corresponding one or more authorized entities. More specifically, in an exemplary embodiment, the bot handling module 110 may be configured to handle or consider one or more bots as identities within a corresponding organization unit which is maintained by IT manager. Also, the life cycle of the bot may include, but not limited to start, stop and termination, assignment of access and the like are performed by assigned IT Admin within the organization unit.

All settings are predominantly application settings that have a default value. If the setting is not overridden by at least one of the respective organization unit, managed system, entitlement, or the one or more users, the default application setting value may be used

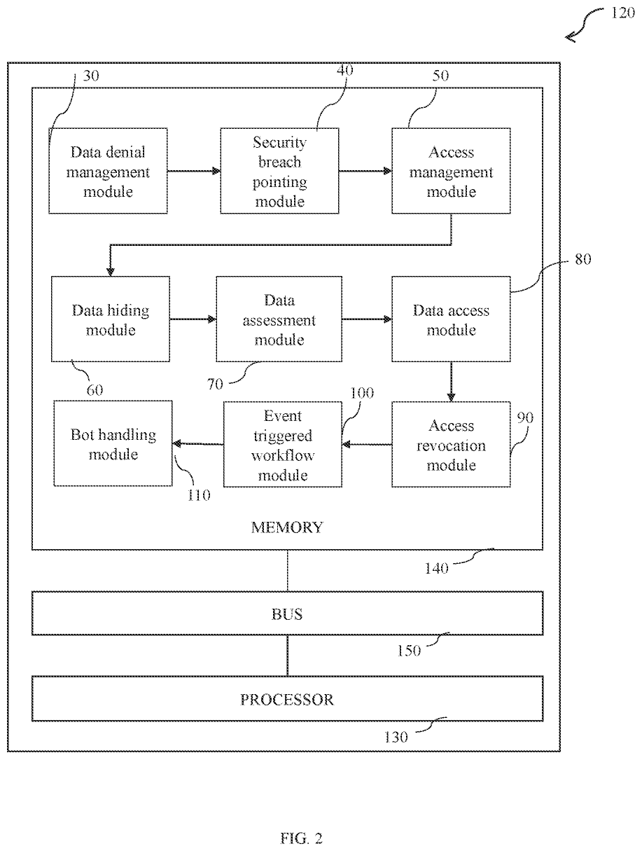

FIG. 2 is a block diagram representation of a processing unit located on a local server or on a remote server in accordance with an embodiment of the present disclosure. The server 120 includes processor(s) 130, and memory 140 operatively coupled to the bus 150.

The processor(s) 130, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

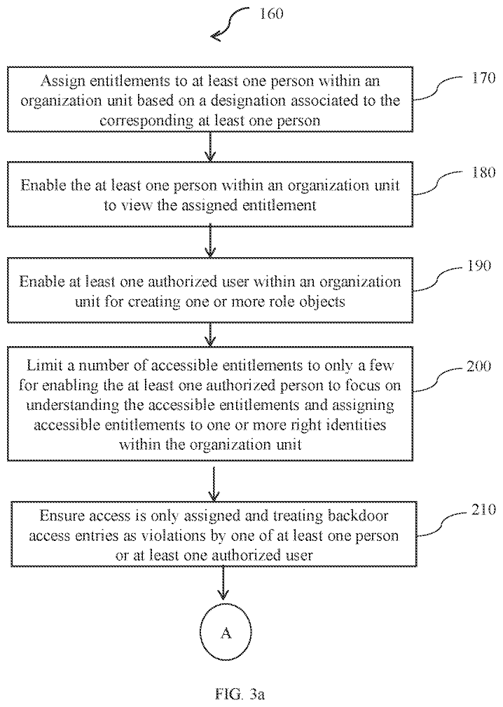

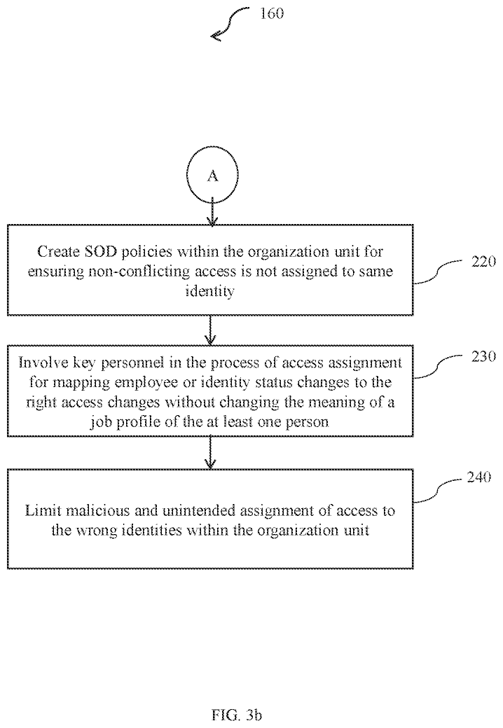

The memory 140 includes a plurality of modules stored in the form of executable program which instructs the processor 130 to perform the method steps illustrated in FIG. 3a and FIG. 3b. The memory 140 is substantially similar to the system 10 of FIG. 1. The memory 140 has the following modules: a data denial management module 30, a security breach pointing module 40, an access management module 50, a data hiding module 60, a data assessment module 70, a data access module 80 and an access revocation module 90.

The data denial management module 30 configured to restrict one or more users from operating unsolicited access data associated to the organization-unit, wherein the unsolicited data is unassigned to the corresponding one or more users. The security breach pointing module 40 identify one or more violation points by at least one of the one or more users happened within the organization based on violation of one or more policies by the corresponding one or more users, wherein the one or more policies is created by one or more authorized entities within the organization and to identify one of illegitimate assignments or back door entry access assignments by the one or more users, upon comparing access data present on identity of the organization with assigned access data of the corresponding one or more users using one or more attributes associated to the corresponding one or more users. The access management module 50 is configured to detect one or more parameters associated with a status of the corresponding one or more users.

The data hiding module 60 configured to restrict access of data associated with the one or more authorized entities, to the one or more users, based on one or more organization hierarchy. The data assessment module 70 configured to generate a score representative of a criticality level of the access of data of at one of the organizations, the one or more authorized entities, or a combination thereof, by the one or more users. The data access module 80 configured to grant an access to at least one of the one or more user, the one or more authorized entities, or a combination thereof to access the data associated to the organization, based on one or more conditions. The access revocation module 90 configured to revoke access of at least one of the one or more user, the one or more authorized entities, or a combination thereof upon accessing the data associated to the organization upon execution of a pre-set instructions.

FIGS. 3a and 3b are flow charts representing steps involved in a method 160 for access management in an organization in accordance with an embodiment of the present disclosure. The method includes assigning entitlements to at least one person within an organization unit based on a designation associated to the corresponding at least one person in step 170. The method also includes enabling the at least one person within an organization unit to view the assigned entitlement in step 180. The method also includes enable at least one authorized user within an organization unit for creating one or more role objects, wherein creating one or more role objects comprises IT roles and organization roles fitting various IT functions of the organization unit in step 190. The method further includes limiting a number of accessible entitlements to only a few for enabling the at least one authorized person to focus on understanding the accessible entitlements and assigning accessible entitlements to one or more right identities within the organization unit in step 200. The method also includes ensuring access is only assigned and treating backdoor access entries as violations by one of at least one person or at least one authorized user in step 210. The method also includes creating SOD policies within the organization unit for ensuring non-conflicting access is not assigned to same identity in step 220. The method also includes involving key personnel in the process of access assignment for mapping employee or identity status changes to the right access changes without changing the meaning of a job profile of the at least one person in step 230. The method also includes limiting malicious and unintended assignment of access to the wrong identities within the organization unit in step 240.

In one exemplary embodiment the method 160 includes restricting one or more users from operating unsolicited data associated to the organization. In one embodiment, restricting the one or more users comprises restricting the one or more users by a data denial management module.

The method 160 includes identifying one or more violation points by at least one of the one or more users happened within the organization based on violation of one or more policies by the corresponding one or more users. In one embodiment, identifying the one or more violation points may include identifying the one or more violation points by a security breach pointing module.

Furthermore, the method 160 includes identifying one of illegitimate assignments or back door entry access assignments by the one or more users, upon comparing access data present on identity of the organization with assigned access data of the corresponding one or more users using one or more attributes associated to the corresponding one or more users. In one embodiment, identifying one of illegitimate assignments or back door entry access assignments may include identifying one of illegitimate assignments or back door entry access assignments by the security breach pointing module.

The method 160 also includes detecting the one or more parameters associated with a status of the corresponding one or more users. In one embodiment, detecting one or more parameters may include detecting the one or more parameters by an access management module. In one exemplary embodiment, detecting the one or more parameters may include detecting at least one of an identity status change event, a responsibility change, or a combination thereof within the organization.

The method 160 also includes restricting access of data associated with the one or more authorized entities, to the one or more users, based on one or more organization hierarchy. In one embodiment, restricting access of the data may include restricting access of the data by a data hiding module.

Furthermore, the method 160 also includes generating a score representative of a criticality level of the access of data of at one of the organization, the one or more authorized entities, or a combination thereof, by the one or more users. In one embodiment, generating the score may include generating the score by a data access module.

The method 160 also includes granting an access to at least one of the one or more user, the one or more authorized entities, or a combination thereof to access the data associated to the organization, based on one or more conditions. In one embodiment, granting the access may include granting the access by a data access module. In one embodiment, granting the access based on the one or more conditions may include granting the access based on at least one of a customer identity, work time comprising a date and time to solicit logging credentials of the one or more users within the organization, or a combination thereof.

The method 160 also includes revoking an access of at least one of the one or more user, the one or more authorized entities, or a combination thereof upon accessing the data associated to the organization upon execution of a pre-set instructions. In one embodiment, revoking the access may include revoking the access by an access revocation module.

In one exemplary embodiment, the method 160 may further include managing one or more bots as identities within a corresponding organization unit which is maintained by the one or more authorized entities, wherein the operation of the bot comprises start, stop and termination, assignment of access, or a combination thereof to be performed upon being assigned by the corresponding one or more authorized entities. In such embodiment, managing the one or more bots by a bot handling module.

In one specific embodiment, the method may further include dividing all entitlements within organization across organization units for enabling accessibility only to functions which aligns with the function of the entitlements. The method may further include dividing entitlements across job profiles and protecting the divided entitlements with policies so that conflicting job profiles are never assigned conflicting accesses. The method may further include providing view of all accesses assigned during each step of the identity lifecycle event of the corresponding identity within the organization unit. The method may further include separating duties for ensuring identity change events are handled as per the role within organization unit. The method may further include permitting easy implementation of secondary organization unit assignment to identity. The method may further include triggering configurable workflow processes whenever identity change event occurs so that one or more authorized entities have cognizance of the change and the access change involved. The method may further include incorporating entitlement changes of the organization role for assigning or unassigning the changes to respective identities. In such embodiments, the method may further include performing access data hiding so that only authorized persons can view and operate the same. The method may further include disabling direct assignment of access to identity even if the assigner is manager. The method may further include time bounding the requested access to auto-revoke once time is up.

It should be noted that all the elements of FIGS. 3a and 3b are substantially similar to elements of FIG. 1, henceforth all the embodiments of FIG. 1 hold good for FIGS. 3a and 3b.

Various embodiments of the present disclosure enable the system to distribute access data only where necessary, and other OUs are not permitted to even know if the access or even the service or server exists. Also, the system provides clarity and view of what access is used where. Thereby knowing what resources and what servers/services are used by what OUs. Further, the system ensures involvement of relevant personnel IT admin, HR, manager or the one or more authorized users in various steps during access provisioning. The system ensures if any access is not assigned to the identity directly by any personnel but goes through workflow involving relevant personnel. In addition, the system ensures assigned access is defined by job profile and designation of employee.

Furthermore, the system ensures initiation of identity state change access provisioning is by HR only. SOD policies at entitlement level and IT access level ensures conflicting access are never assigned to identity. Policy checks are made before access assignment. Organization unit identity entitlements to be checked with policies relevant only to organization unit and global policies. Also, custom settings for specific organization unit, managed system and entitlement enables custom behavior, thereby making the system more reliable and efficient.

Moreover, the system Tracks who has what access, whether they are having only what has been assigned, that all stale user accesses are removed from time to time; Ensures all accesses on applications, servers and resources are legitimate ones; provides access certification subsystems to ensure all accesses are valid ones. The system makes the access management seamless with organizational working. This gives a better understanding and clear perspective of the access data and the working of the IAM solution visa vis organization functions.

In addition, the system is able to organize thousands of access data or IT resources across the organization and a view of where is what and what is where. Also, the access management is more management driven than IT driven, the introduction of the whopping IT related data in the form of IT roles and becomes an overkill for management to handle or rather forced to handle. Management should be agnostic of the IT related info and at the same time in control of the access authorization. The solution should be able to provide simple constructs easily understood by management and drive the access provisioning based on access requirements of the requesting identity.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for access management in an organization comprising:
one or more processors;
a data denial management module operable by the one or more processors, and configured to restrict one or more users from operating unsolicited data associated to the organization, wherein the unsolicited data is unassigned to the corresponding one or more users;
a security breach pointing module operable by the one or more processors, and configured to:
identify one or more violation points by at least one of the one or more users within the organization based on violation of one or more policies by the corresponding one or more users, wherein the one or more policies is created by one or more authorized entities within the organization;
identify one of illegitimate assignments or back door entry access assignments by the one or more users, upon comparing access data present on identity of the organization with assigned access data of the corresponding one or more users using one or more attributes associated to the corresponding one or more users;
an access management module operable by the one or more processors, and configured to:
detect one or more parameters associated with a status of the corresponding one or more users;
trigger one or more workflows pertaining to the change event and assigns dicta of personnel based upon the task or step involved;
a data hiding module operable by the one or more processors, and configured to restrict access of data associated with the one or more authorized entities, to the one or more users, based on one or more organization hierarchy;
a data assessment module operable by the one or more processors, and configured to generate a score representative of a criticality level of the access of data of at one of the organization, the one or more authorized entities, or a combination thereof, by the one or more users;
a data access module operable by the one or more processors, and configured to grant an access to at least one of the one or more user, the one or more authorized entities, or a combination thereof to access the data associated to the organization-unit, based on one or more conditions; and
an access revocation module operable by the one or more processors, and configured to revoke access of at least one of the one or more user, the one or more authorized entities, or a combination thereof upon accessing the data associated to the organization upon execution of a pre-set instructions.

2. The system as claimed in claim 1, wherein the one or more parameters comprises at least one of an identity status change event, a responsibility change, or a combination thereof within the organization.

3. The system as claimed in claim 1, wherein the one or more conditions comprises at least one of a customer identity, work time comprising a date and time to solicit logging credentials of the one or more users within the organization, or a combination thereof.

4. The system as claimed in claim 1, comprising an event triggered workflow module operable by the one or more processors, and configured to operate an access to of the one or more users based on one or more events associated to the one or more users.

5. The system as claimed in claim 1, comprising a bot handling module operable by the one or more processors, and configured to manage one or more bots as identities within a corresponding organization unit which is maintained by the one or more authorized entities, wherein the operation of the bot comprises start, stop and termination, assignment of access, or a combination thereof to be performed upon being assigned by the corresponding one or more authorized entities.

6. A method for access management in an organization comprising:
assigning entitlements to at least one person within an organization unit based on a designation associated to the corresponding at least one person;
enabling the at least one person within an organization unit to view the assigned entitlement;
enabling at least one authorized user within an organization unit for creating one or more role objects, wherein creating one or more role objects comprises IT roles and organization roles fitting various IT functions of the organization unit;
limiting a number of accessible entitlements to only a few for enabling the at least one authorized person to focus on understanding the accessible entitlements and assigning accessible entitlements to one or more right identities within the organization unit;
ensuring access is only assigned and treating backdoor access entries as violations by one of at least one person or at least one authorized user;
creating SOD policies within the organization unit for ensuring non-conflicting access is not assigned to same identity;
involving key personnel in the process of access assignment for mapping employee or identity status changes to the right access changes without changing the meaning of a job profile of the at least one person; and
limiting malicious and unintended assignment of access to the wrong identities within the organization unit.

7. The method as claimed in claim 6, comprising:
dividing all entitlements within organization across organization units for enabling accessibility only to Organization-Unit functions which aligns with the function of the entitlements;
dividing entitlements across job profiles and protecting the divided entitlements with policies so that conflicting job profiles are never assigned conflicting accesses;
providing view of all accesses assigned during each step of the identity lifecycle event of the corresponding identity within the organization unit;
separating duties for ensuring identity change events are handled as per the role within organization unit;
permitting easy implementation of secondary organization unit assignment to identity;
triggering configurable workflow processes whenever identity change event occurs so that one or more authorized entities have cognizance of the change and the access change involved; and
incorporating entitlement changes of the organization role for assigning or unassigning the changes to respective identities.
